(19) United States
(12) Patent Application Publication
(10) Pub. No.: US 2012/0325057 A1
(43) Pub. Date: Dec. 27, 2012

(54) FOLDING HAND TOOL

(76) Inventor: Shih-Chi Ho, Taichung City (TW)

(21) Appl. No.: 13/166,268

(22) Filed: Jun. 22, 2011

(51) Int. Cl. B25B 15/04; B25B 23/16

(52) U.S. Cl. 81/60; 81/177.8

(57) ABSTRACT

A foldable hand tool has a handle and a tool's driving head. The tool is mainly characterized by that, the handle is provided with a driving head guide groove, which is extended along the handle and set correspondingly with the handle's long guide hole. The driving head guide groove penetrates one side of the handle. A combined lug is protruded from the assembly end of the tool's driving head, and fitted slidably with the driving head guide groove of the handle. When the tool's driving head swings perpendicular to the handle, it can slide along the driving head guide groove. With the arrangement of said driving head guide groove, the hand tool can be configured into a straight or T-shaped pattern, thus improving the ease-of-operation and flexibility to meet the customer demands with higher applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a ratchet type tool, and more particularly to an innovative one which can be folded for further use.

2. Description of Related Art Including Information Disclosed Under 37 CFR 1.97 and 37 CFR 1.98.

Given the fact that the conventional hand tool for locking or unlocking of screws and nuts must be firstly disengaged and then reversely set or rotated, this requires development of novel ratchet type tools, such as ratchet spanners, ratchet screwdrivers and ratchet sockets, so as to address such kinds of problems.

Notwithstanding a variety of ratchet type tools with different structures in the relevant industry, the present invention intends to improve said ratchet screwdriver. In fact, a foldable ratchet screwdriver has been developed for some special operating environments. However, the head of an existing ratchet screwdriver can only swing at the active end of the handle, leading to insufficient structural or functional flexibility.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The enhanced efficacy of the present invention is as follows:

According to the unique construction of the present invention, the “foldable hand tool” is mainly characterized by that, the handle is provided with a driving head guide groove, and the tool's driving head is provided with a combined lug, so the tool's driving head can be extended to the handle's active end in a straight pattern, or folded into an L-shaped pattern. Or with the fitting of the driving head guide groove and combined lug, the tool's driving head could slide along the driving head guide groove and is then locked onto the handle body in a T-shaped pattern, thus improving the ease-of-operation and flexibility to meet the customer demands with higher applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an upper perspective view of the hand tool of the present invention.

FIG. 2 is an exploded perspective view of a preferred embodiment of the present invention.

FIG. 3 is an assembled sectional view of a preferred embodiment of the present invention.

FIG. 4 is a schematic view of the present invention wherein the hand tool is used in a straight pattern.

FIG. 5 is a schematic view of the present invention wherein the hand tool is used in an L-shaped pattern.

FIG. 6 is a schematic view of the present invention wherein the hand tool is used in a T-shaped pattern.

### DETAILED DESCRIPTION OF THE INVENTION

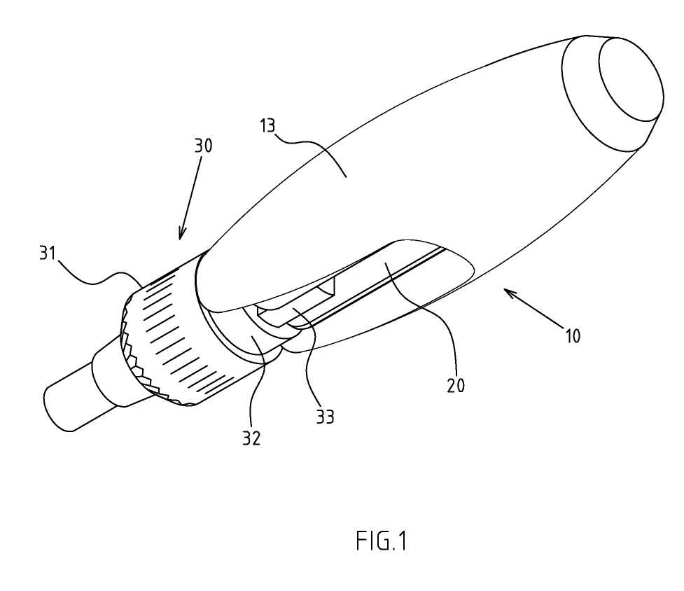

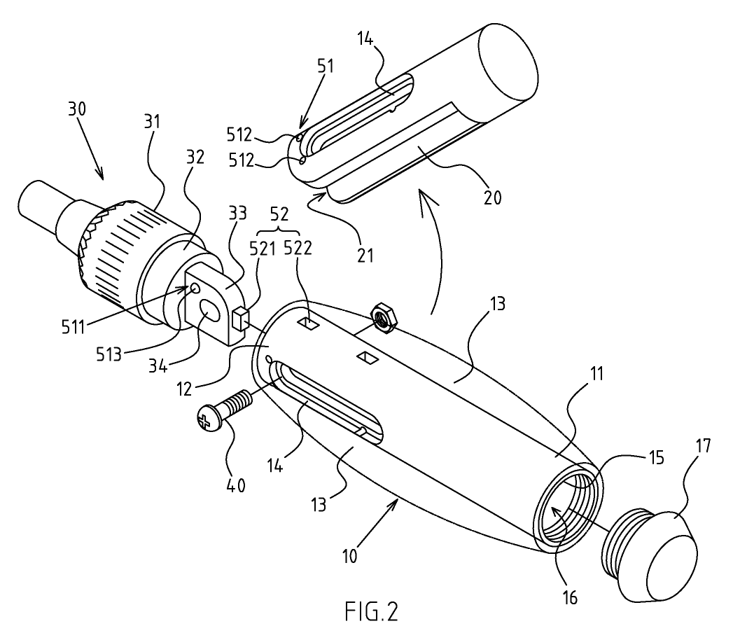

FIGS. 1-2 depict preferred embodiments of a foldable hand tool of the present invention, which, however, are provided for only explanatory objective for patent claims. Said hand tool is a ratchet screwdriver, comprising a handle 10 in an elongated pattern, comprising of a holding end 11, an active end 12 and two side walls 13. A long guide hole 14 set on the handle body penetrates two side walls 13 of the handle 10.

A driving head guide groove 20 is extended perforatively along the handle 10 to the end of the handle body for forming an end opening 21. A long guide hole 14 set on two side walls 13 of the handle 10 penetrates vertically the driving head guide groove 20.

A tool's driving head 30 is combined rotatably with said handle 10, such that it can be extended to the active end 12 of the handle 10 or run perpendicular to the handle 10 via swinging. Of which the tool's driving head 30 has an active head 31 and an assembly end 32.

A combined lug 33 is protruded from the assembly end 32 of the tool's driving head 30, and is fitted slidably with the driving head guide groove 20 of the handle 10. When the tool's driving head 30 swings perpendicular to the handle 10, it can slide along the driving head guide groove 20.

A locking member 52 has a locking lug 521 protruded from the combined lug 33 and some dents 522 arranged at interval on the handle body. When the tool's driving head 30 runs perpendicular to the handle 10, it can be locked securely through interlocking of the locking lug 521 and dents 522.

A long through-hole 34 is set on the combined lug 33 of the tool's driving head 30, and extended along the tool's driving head 30. Moreover, the tool's driving head 30 can shift forwards or backwards via the extension of the long through-hole 34, such that the locking lug 521 and dents 522 are combined or disengaged. Of which, the tool's driving head 30 permits a locator 40 to penetrate the long guide hole 14 and long through-hole 34 of the handle 10 for assembly positioning, such that the tool's driving head 30 can swing by taking said locator 40 as a pivot.

A locating element 50 is set oppositely to the handle 10 and tool's driving head 30, allowing to locate stably the tool's driving head 30.

With the arrangement of said driving head guide groove 20, the hand tool can be designed into a straight or T-shaped or L-shaped pattern.

Referring to FIG. 2, a bead set 511 of the locating element 50 is set on the combined lug 33 of said tool's driving head 30, and a plurality of locating slots 512 is set on the active end 12 and handle body of the handle 10. Moreover, the bead set 511 is provided with an elastic element and a bead 513. Said bead 513 is protruded elastically and locked into any locating slot 512 of the handle 10.

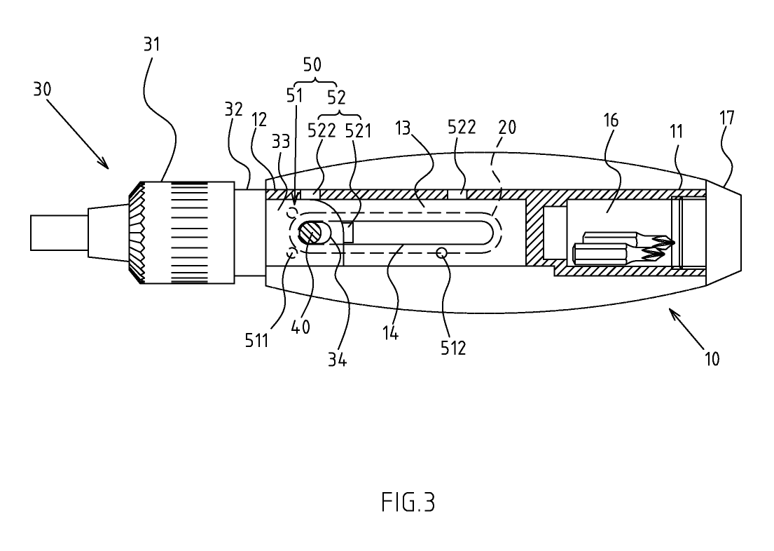

Of which, a holding space 16 with opening 15 is set on the holding end 11 of the handle 10, and opened or closed via a lid 17. Said holding space 16 is used to accommodate different tool heads for the users (in collaboration with FIGS. 2, 3).

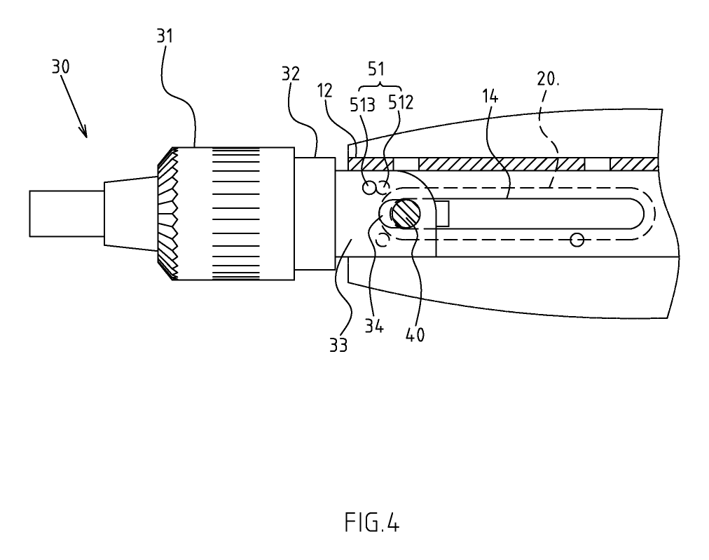

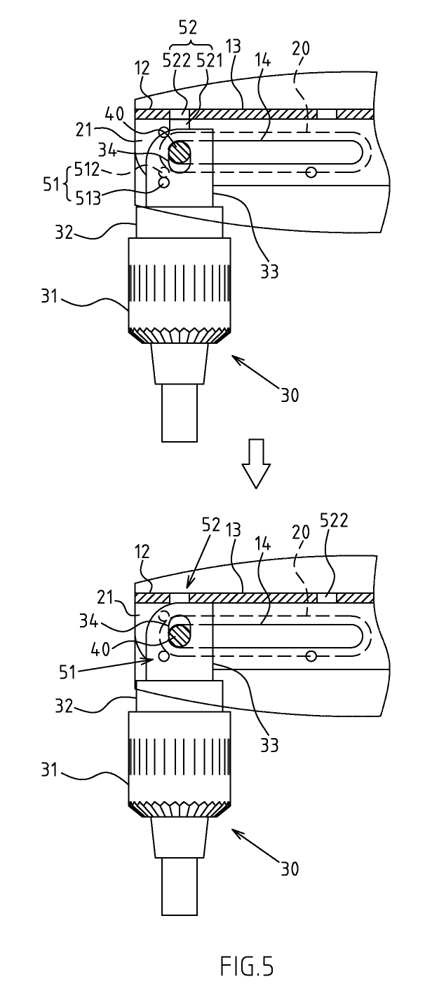

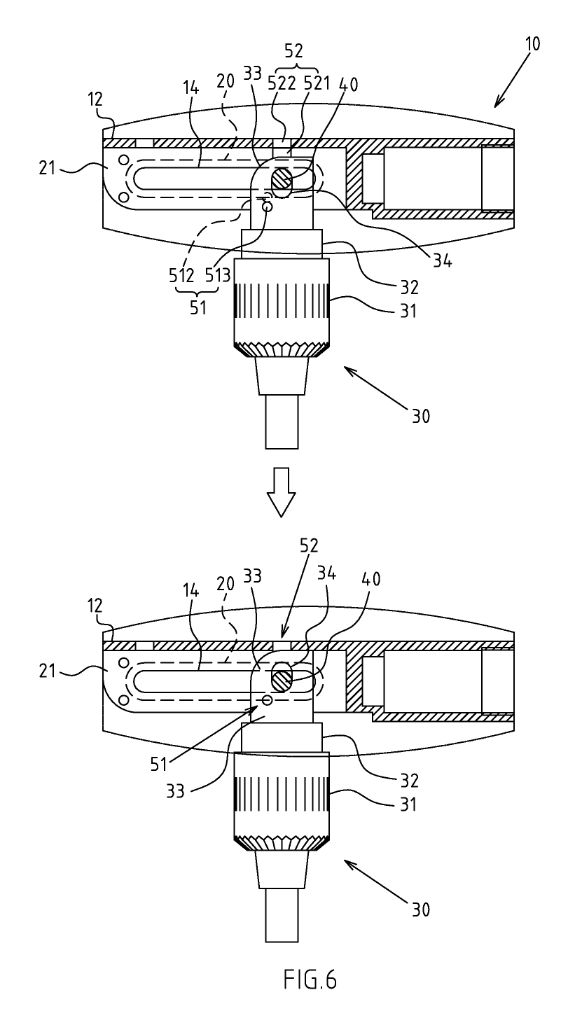

Based on above-specified structural configuration, the core element of the hand tool of the present invention lies in that, the handle 10 is provided with a driving head guide groove 20, and the tool's driving head 30 is provided with a combined lug 33, the tool's driving head 30 can be designed into a straight or T-shaped pattern. In this preferred embodiment, the hand tool is used in such a manner that the long through-hole 34 of the tool's driving head 30 is fitted with the locator 40 and locating element 50. When the tool's driving head 30 isn't rotated, it is extended to the active end 12 of the handle 10, and locked into the first locating slot 512 of the handle 10 via the bead set 511, so that the hand tool is used in a straight pattern (disclosed in FIGS. 3, 4). When the tool's driving head 30 is rotated, it is forcibly pulled outwards with the arrangement of the long through-hole 34 and elastic setting of the bead set 511, so that the tool's driving head 30 could swing flexibly to one side of the active end 12 of the handle 10, and the locking lug 521 is locked into the first dent 522. The bead set 511 is locked into the second locating slot 512 of the handle 10, so that the tool's driving head 30 can be locked securely. With this configuration, the hand tool is used in an L-shaped pattern(shown in FIG. 5). Next, referring also to FIG. 6, when the tool's driving head 30 is pulled by the force applied by the user, and the locking lug 521 is disengaged from the first dent 522, the tool's driving head 30 slide along the driving head guide groove 20. When the locking lug 521 is located correspondingly to the second dent 522, the tool's driving head 30 can be locked securely since the locking lug 521 and the second dent 522 are interlocked, and the bead set 511 is locked into the third locating slot 512 of the handle 10. In such case, the assembly state of said tool's driving head 30 is stable and reliable, and such hand tool is used in a T-shaped pattern.

1. A foldable hand tool, comprising:
a handle in an elongated pattern, comprising of a holding end, an active end and two side walls;
a driving head guide groove, extended perforatively along the handle to the end of the handle body for forming an end opening; a long guide hole set on two side walls of the handle penetrates vertically the driving head guide groove;
a tool's driving head, combined rotably with said handle, such that it can be extended to the active end of the handle or run perpendicular to the handle via swinging; of which the tool's driving head has an active head and an assembly end;
a combined lug, protruded from the assembly end of the tool's driving head, and fitted slidably with the driving head guide groove of the handle; when the tool's driving head swings perpendicular to the handle, it can slide along the driving head guide groove;
a locking member, comprising of a locking lug protruded from the combined lug and a plurality of dents arranged at interval on the handle body; when the tool's driving head runs perpendicular to the handle, it can be locked securely through interlocking of the locking lug and dents;
a long through-hole, set on the combined lug of the tool's driving head, and extended along the tool's driving head; moreover, the tool's driving head can shift forwards or backwards via the extension of the long through-hole, such that the locking lug and dents are combined or disengaged; of which, the tool's driving head permits a locator to penetrate the long guide hole and long through-hole of the handle for assembly positioning, such that the tool's driving head can swing by taking said locator as a pivot;
a locating element, set oppositely to the handle and tool's driving head, allowing to locate stably the tool's driving head;
with the arrangement of said driving head guide groove, the hand tool can be configured into a straight or folded in T-shaped pattern.

2. The structure defined in claim 1, wherein said hand tool is a ratchet screwdriver.

3. The structure defined in claim 1, wherein a bead set of the locating element is set on the combined lug of said tool's driving head, and a plurality of locating slots is set on the active end and handle body of the handle; moreover, the bead set is provided with an elastic element and a bead; said bead is protruded elastically and locked into any locating slot of the handle.

4. The structure defined in claim 1, wherein a holding space with opening is set on the holding end of the handle, and opened or closed via a lid.

5. The structure defined in claim 1, wherein said hand tool can be folded into an L-shaped pattern.
